(19) United States
(12) Patent Application Publication
(10) Pub. No.: US 2026/0008622 A1
(43) Pub. Date: Jan. 8, 2026

(54) Device for providing a barrier, use and roller deck

(71) Applicant: Deutsche Post AG, Bonn (DE)

(72) Inventors: Hendrik Meiner, Leipzig (DE); Marc Naumann, Leipzig (DE)

(21) Appl. No.: 19/258,350

(22) Filed: Jul. 2, 2025

(30) Foreign Application Priority Data
Jul. 5, 2024 (DE) 10 2024 119 235.6

(51) Int. Cl. B65G 7/04; B65G 39/12

(52) U.S. Cl. CPC B65G 7/04; B65G 39/12; B65G 2201/022; B65G 2201/0235; B65G 2205/02; B65G 2207/34

(57) ABSTRACT

A device for providing a barrier for objects resting on a roller deck, wherein the roller deck includes a loading area provided with openings, wherein roller elements for supporting the objects protrude from the openings, and wherein the roller elements are each arranged rotatably about a vertical axis and about a horizontal axis is disclosed. The device includes at least two securing devices, each having an insertion portion for insertion into one of the openings of the roller deck and a support portion for support on a region of the loading area surrounding the opening, and a connecting device for providing a mechanical connection between two securing devices of the at least two securing devices.

The present application is based upon and claims the right of priority to DE Patent Application No. 10 2024 119 235.6, filed Jul. 5, 2024, the disclosure of which is hereby incorporated by reference herein in its entirety for all purposes.

The invention relates to a device for providing a barrier for objects resting on a roller deck.

Roller decks, also known as castor decks, are well known in practice. A roller deck has a loading area with roller elements for supporting objects. The roller elements are each rotatable. Objects, for example containers with a mostly flat underside, can be moved on the roller deck, wherein the roller elements enable the object to move along the loading area with as little friction as possible. There is a need to fix the objects on the roller deck in a practicable manner, for example by providing a barrier for this purpose, taking into account occupational safety and ergonomics.

DE 602 26 198 T2 describes a swivelling castor for a transport system which comprises an upper platform and in which the castor comprises a wheel which is attached to a wheel shaft by means of a first roller bearing.

CN 1 12 550 112 A describes a freight floor and a freight wagon.

DE 10 2017 202 260 A1 a device for securing cargo on a loading area of a vehicle, in particular a motor vehicle.

Based on this, the problem addressed by the invention is that of providing solutions that improve the fixing of objects on roller decks. In particular, the solutions known from the prior art are to be improved or alternative solutions are to be created. In particular, disadvantages of solutions known from the prior art are to be avoided or at least substantially reduced.

This problem is solved by the subject matter of the independent claims. In particular, the invention is defined in the independent claims. Preferred embodiments of the invention can be found in the dependent claims, in the figures and in the following description.

A device for providing a barrier for objects resting on a roller deck is proposed. The roller deck, which is particularly suitable for the device, has a loading area provided with openings. Roller elements for supporting the objects protrude from the openings. The roller elements are each arranged to be rotatable or rotatable about a vertical axis and about a horizontal axis. It is proposed that the device has the following:
at least two securing devices, each comprising an insertion portion for insertion into one of the openings of the roller deck and a support portion for support on a region of the loading area surrounding the opening, and
a connecting device for providing a mechanical connection between two securing devices of the at least two securing devices.

In other words, for example, a blocking device is proposed for a castor deck provided with rollers, which blocking device has two blocking elements and a connecting element. The blocking elements are designed to be inserted into openings for the castor deck rollers, wherein the connecting element connects the blocking elements.

The invention realizes the idea of using the openings provided with roller elements in a roller deck in order to provide a barrier there. In addition to the roller elements, the openings regularly offer sufficient engagement possibilities for inserting the insertion portion, for example in the form of a projection, in order to deactivate the roller element on the one hand and to create a physical blockade along the loading area by means of form fit on the other. The support portion can be well supported in the immediate vicinity of the openings.

The roller deck can also be referred to as a caster deck or castor deck. This is a device known from the prior art for moving objects in a simplified manner. The objects can rest on the roller deck.

The objects are usually transport containers, in particular with a flat underside. For example, the objects may be pallets, cartons, ULD containers or similar objects for packaging and/or transport. “ULD” stands for “Unit Load Device”. The objects can be free of rollers or roller elements on the underside.

The device can provide a barrier for objects resting on a roller deck. The barrier can be understood as a blockade or stop for the objects. For example, the device can represent a path restriction for the objects. The device can be understood as a tool or aid for maintaining the barrier on a roller deck.

The roller deck has a loading area. The loading area is regularly made of sheet metal, for example perforated sheet metal and/or perforated sheet metal segments. Several of the sheet metal segments can be assembled to provide the loading area or form the loading area. The loading area extends in particular at least substantially in one plane, in particular the plane in which the roller elements protrude. The loading area can be held or supported by a base structure of the roller deck. The roller elements can be attached to the base structure. The base structure is regularly located below the loading area and/or the roller elements.

The loading area is provided with the openings or has the openings, in particular at least ten or at least fifty or more openings. The openings are, for example, round in shape and/or distributed in a plane formed by the loading area. The openings are formed or shaped, for example, by a border or edging. The openings or edgings are, for example, worked into the loading area, in particular cut and/or punched into it. Furthermore, the roller elements are provided, which protrude from the openings to support the objects or protrude from the openings in portions, in particular to form individual contact points for the objects, which are preferably designed to roll off the objects.

The openings or their edgings are each surrounded by a region. The loading area next to a respective opening can directly surround this opening and form said region there (in particular the “region of the loading area surrounding the opening”), on which the device can be supported or can rest on. For example, the region is annular and/or extends over a large area.

For example, the roller elements are transport castors and/or steering castors. The roller elements regularly have two pivot axes or axes of rotation about which the components of the roller element can rotate in relation to each other. The vertical axis can run at least substantially perpendicular to the loading area or its plane. The horizontal axis can run at least substantially perpendicular to the vertical axis and/or at least substantially parallel to the loading area. The horizontal axis can run below, substantially in or above the plane formed by the loading area.

Preferably, the roller element has a base part, a swivelling part and/or a roller. The base part can be attached in the opening of the loading area or to a base structure of the roller deck or is attached there. The swivelling part is preferably held on the base part so that it can rotate about the vertical axis, in particular by means of a roller bearing. The roller is preferably held in the swivelling part so that it can rotate about the horizontal axis, in particular by means of a roller bearing. It is preferable for the swivelling part to provide a distance between the vertical axis and the horizontal axis. The swivelling part can have a toe guard that extends at least substantially over a large region and is arranged or positioned at least substantially in the plane of the loading area. The toe guard can form a surface lying in the horizontal axis and/or running parallel to it. The toe guard can have one or more recesses in order to gain access along the vertical axis into the opening and/or to the base part. The recess or recesses are preferably arranged on the edge of the toe guard, for example adjacent to the edge of the opening. The toe guard can be shaped at least substantially round and/or corresponding to the opening, in particular smaller than the opening.

The roller elements preferably protrude from the openings in such a way that all the upper sides of the roller elements are at least substantially in a common plane and/or at the same height, preferably above the loading area. Objects can be placed on the loading area, in particular on the roller elements. The objects can rest on one or more of the roller elements substantially point by point. The objects can be moved with little friction by rolling on the roller element(s).

The roller elements are each arranged to rotate about a vertical axis and a horizontal axis. The vertical axis is intended to indicate that the axis can be regularly aligned high, pointing upwards or vertically. The horizontal axis is intended to mean that the axis can be regularly horizontal or aligned horizontally. The vertical axis can also be understood or referred to as a first axis and the horizontal axis as a second axis.

At least two securing devices are provided. In this respect, substantially identical securing devices can be provided. Preferably, each securing device is designed to fit an opening, so that the at least two securing devices can be inserted or inserted into two openings, for example.

For the sake of simplicity, the term “the securing device” or “the securing devices” is used in particular in the present case, wherein what is written may refer to one, several or all of the securing devices contained in the respective device, i.e. in particular to “the at least two securing devices”.

The securing devices each have an insertion portion for insertion. The insertion portion can, for example, have a projection that can correspond to a recess, to the opening and/or to the roller element. Several projections, for example two or more, can also be provided. The insertion portion can be inserted, in particular to provide a form fit between the securing device and the roller deck along the loading area.

The securing devices each have a support portion for support on the loading area, in particular for support on a region of the loading area surrounding the opening. The support portion can be formed by one or more flat portions and/or by one or more projections. The support portion can extend at least in one plane. For example, the support portion is larger than the opening in order to be able to rest on the loading area in the immediate vicinity of the opening. The support portion can be designed for at least partial circumferential support on the region of the loading area surrounding the opening.

The securing device can have a deflection portion. The deflection portion can be arranged adjacent to the support portion. The deflection portion can have a slope, which can be arranged above and/or opposite or facing away from the support portion and/or from the opening of the roller deck. The deflection portion or the slope can form a ramp extending from the loading area. For example, the deflection portion can be arranged circumferentially in relation to the support portion. A force introduced into the device along the loading area can, for example, be deflected upwards or in a vertical direction by means of the deflection portion and, for example, be deflected to a stop portion preferably comprising a flexible element.

The connecting device is designed or intended to provide a mechanical connection between two securing devices of the at least two securing devices. In addition, the respective securing devices can be designed to fit. This means, for example, that the connecting device provides a means of fixing the securing devices relative to each other and/or securing them to each other, in particular in at least one, in several or in all directions. The connecting device can enable force transmission between the securing devices. For example, the connecting device can be designed as a rod that can transmit a torque and/or a longitudinal force, in particular a tensile force and/or a compressive force, and/or a transverse force. The connecting device is preferably at least partially or completely rigid. The connecting device can be fixed or fastened to the securing devices. For example, the connecting device and/or the securing device has fastening means for this purpose.

In the region of the support portion, the insertion portion can have one, preferably two, substantially parallel oriented pins or projections for engaging in one of the openings. For example, the insertion portion has two similar pins. The pins can be elongate. When inserted, the pins can extend substantially parallel to the vertical axis. The pins can, for example, engage in the openings, in particular adjacent to the respective roller element and/or engaging in the respective roller element, in order to provide a form fit along the loading area. For example, the pins can engage in a toe guard of the respective roller element, in particular recesses in the toe guard. The insertion portion can be adjacent to and/or at least partially formed by the support portion.

Two of the pins can be provided on one securing device, on both securing devices or on all securing devices of the at least two securing devices. A distance between the pins can be adjustable. For example, a portion of the connecting device, such as the support portion, can have an adjustment mechanism for the insertion portion, in particular for the pins. In this way, the pins can be adapted to different roller decks with an adjustable distance between them. It is also possible that the pins can be fastened, for example screwed, at different points on the insertion portion and/or the support portion in order to be able to adjust the distance between the pins.

The support portion can have an inclined and/or concave shape, especially on the underside, in order to provide a distance from the roller element or not to rest on it or not to rest on it completely.

The support portion can be provided with a coating, for example a non-slip coating and/or a rubber coating. This allows the securing device to adhere better to the roller deck.

The at least two securing devices can each have a stop portion, in particular with a flexible element, for attaching the objects. The stop portion can be adjacent to the support portion. The stop portion can have an opening, for example in which the flexible element is arranged. The flexible element can have an elastic material, for example rubber. The flexible element can protrude laterally beyond the support portion so that objects can collide with it with as little damage as possible. For example, the stop portion can provide the most protruding portion of a securing device in the radial direction or transversely to the vertical axis when inserted into the roller deck.

The stop portion, in particular the flexible element, can have a spring, for example a spiral spring, in particular a metal spring. The stop portion and/or the spring can be integrated into and/or attached to the support portion and/or the deflection portion. The spring can be encased in rubber or other flexible materials or incorporated therein. The stop portion, in particular the flexible element and/or the spring, can be made of rubber, in particular chloroprene rubber or CR or the like, or comprise same.

The at least two securing devices can have a receiving portion for receiving the connecting device. The receiving portion can be adjacent to the stop portion. For example, the receiving portion may be located opposite the support portion and/or the insertion portion. The receiving portion can have a guide and/or receptacle for the connecting device. The connecting device can be inserted, plugged and/or pushed into the receiving portion.

For example, the receiving portion is designed to guide the connecting device in a detachable and/or adjustable manner. For example, the connecting device can be adjusted or moved in the receiving portion in order to set a distance between the two securing devices connected to the connecting device. The receiving portion can be set up to accommodate two or more connecting devices.

The receiving portion can have a fixing means for fixing the connecting device(s) in the guide or receptacle. For example, the fixing means may have a screw, a split pin, a locking pin, a pin or the like or be designed as such and/or provide a releasable form fit between the receptacle of the receiving portion and the connecting device.

The connecting device can be elongate and/or have a rod. The connecting device is in particular at least 20 cm, preferably at least 30 cm or at least 40 cm long and/or adjustable in length. In particular, the connecting device is telescopic. Telescoping can be provided, for example, by tubes or the like inserted into one another. In elongate form or as a rod, the connecting device can be easily and intuitively picked up by the respective receiving portion. It is therefore possible to design the device to be very compact and still provide an effective barrier. The telescopic design also makes it possible to integrate a damping function.

Three or more of the at least two securing devices and/or two, three or more of the connecting device can be provided, in particular in order to be able to be connected to one another in a row and/or in a triangular shape, and/or in order to be inserted into several, in particular three or more, of the openings of the roller deck. In this respect, two connecting devices can be accommodated and possibly fixed in a securing device in order to form a row or a triangle with the connecting devices and, for example, to have the securing devices at the corner points or bends/corners of the triangle or the row. The corner points or kinks/corners can then be placed in the region of openings in the roller deck and inserted there. For example, the device can be placed in a triangular shape on the roller deck to provide a barrier that is stable from several directions and to create improved visibility. It is also possible to arrange a number of securing devices in a row and connect them to each other using connecting devices. In this way, an elongate barrier can be provided on the roller deck.

Further proposed is a use of a or the device for providing a barrier for objects resting on a roller deck or the castor deck, in particular wherein the roller deck has a loading area provided with openings, wherein roller elements for supporting the objects protrude from the openings, wherein the roller elements are each arranged rotatably about a vertical axis and about a horizontal axis, and/or wherein the device is or will be inserted into two of the openings. It is possible that the roller deck is provided at an airport or a logistics hub. This use makes it possible to simplify operations on the roller deck.

A system with a/the roller deck and with a device for providing a barrier for objects resting on the roller deck is also proposed, wherein the roller deck has a loading area provided with openings, wherein roller elements for supporting the objects protrude from the openings, and/or wherein the roller elements are each arranged rotatably about a vertical axis and about a horizontal axis. The device is in particular the device described here. The system can serve as an integrated solution for transporting objects in a simplified manner and for fixing them on the roller deck in a simplified manner.

In the context of the disclosure, the term “or” is basically intended to indicate in essence alternative, basically equivalent and/or synonymous features or terms in order to bring the idea or meaning of a feature or term use closer. The term “or” can always be replaced with “and/or”.

In the following, the invention is explained in further detail with reference to the drawings by means of a preferred exemplary embodiment.

The drawings show

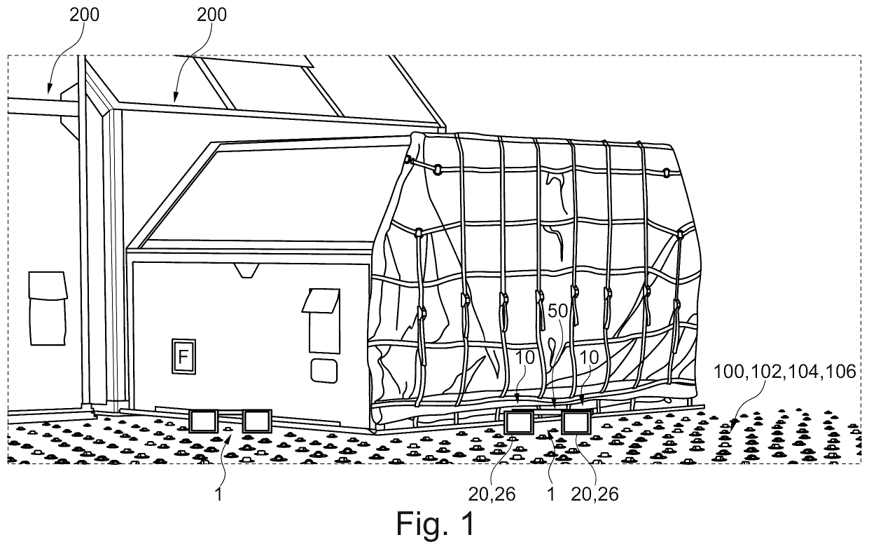

FIG. 1 a perspective view of a system with two devices inserted into a roller deck for providing barriers, wherein objects are arranged on the roller deck,

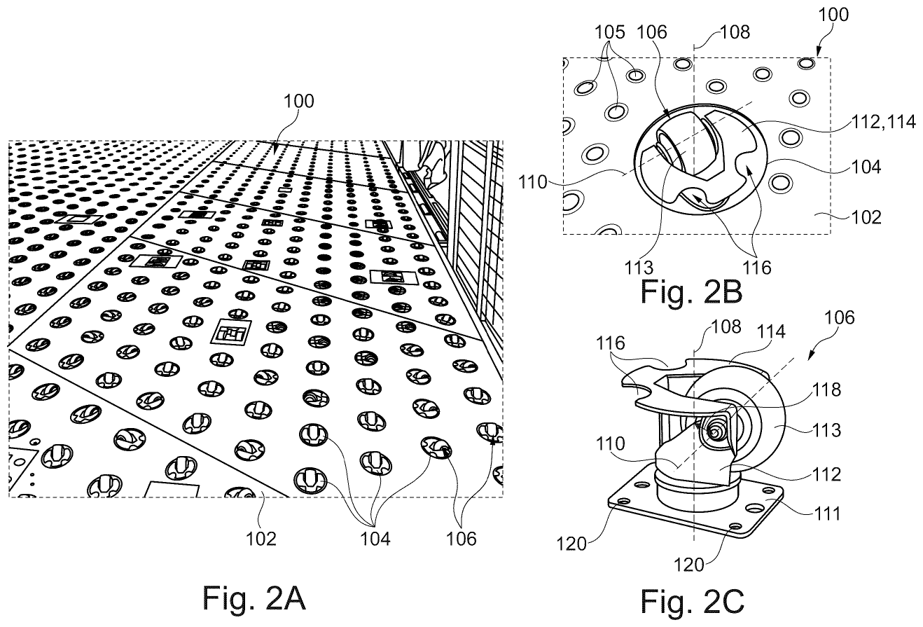

FIG. 2A a roller deck, e.g. that of FIG. 1, in an overall view,

FIG. 2B a roller deck, e.g. that of FIG. 1, in a detailed view of a roller element, FIG. 2C a roller deck, e.g. that of FIG. 1, with a view of only one roller element,

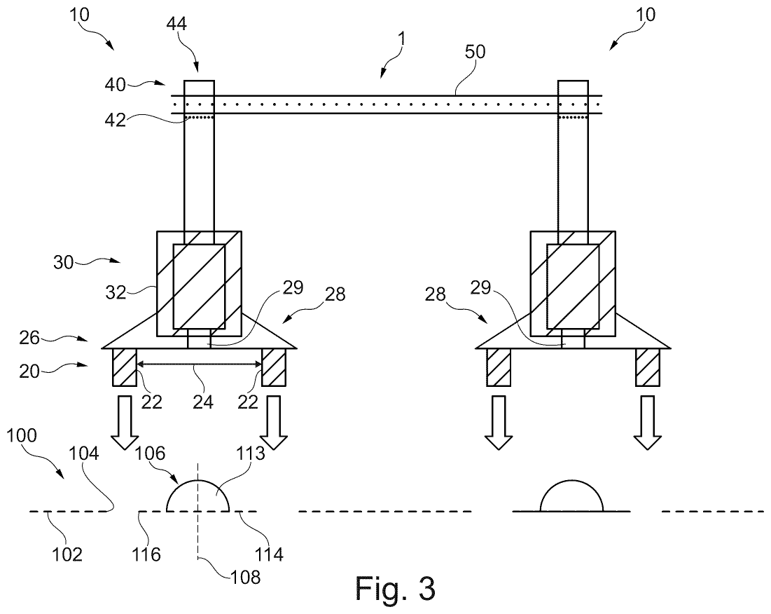

FIG. 3 a device for providing a barrier and with at least two securing devices and a connecting device connecting the securing devices above a roller deck in a schematic view, and in

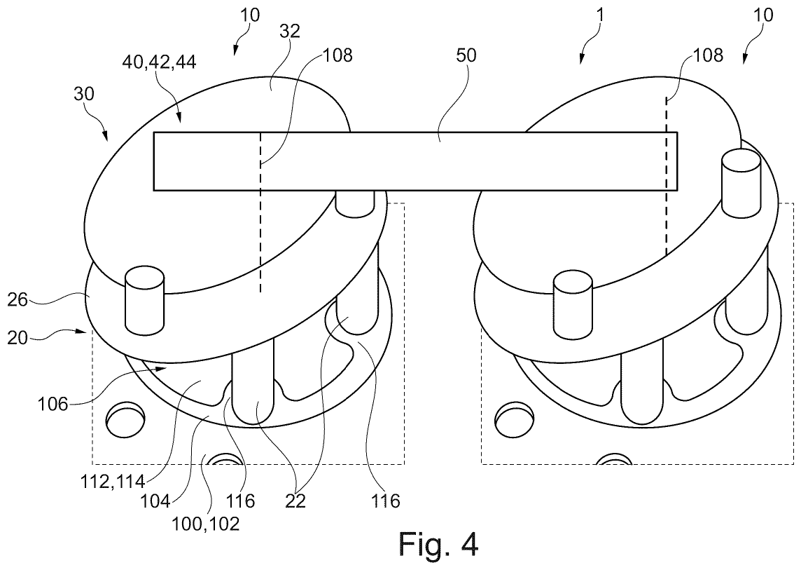

FIG. 4 a perspective view of a device for providing a barrier that is inserted into a roller deck.

FIG. 1 shows a system with two devices 1 for providing a barrier for objects 200 resting on a roller deck 100 and with the roller deck 100. The objects 200 are ULD containers. The roller deck 100 has a loading area 102 provided with a plurality of openings 104, wherein roller elements 106 for supporting the objects 200 protrude from each of the openings 104. The ULD containers can be moved on the roller elements 106 with low friction, in that the ULD containers rest on the roller elements 106 and the stationary roller elements 106 can roll on the ULD containers via point contact. In the present case, the devices 1 form the barriers on two sides of an object 200 so that displacement of the object 200 can be selectively blocked.

The devices 1 each have two securing devices 10, which have an insertion portion 20 for insertion into one of the openings 104 and a support portion 26 for support on a region of the loading area 102 surrounding the opening. Furthermore, each device 1 has a connecting device 50 which provides a mechanical connection between the two respective securing devices 10. The objects 200 can strike against the securing devices 10 in directions along the roller deck 100.

Referring to FIGS. 2A-B, a roller deck 100, for example that of FIG. 1, is shown in more detail. The roller deck 100 has a plurality of openings 104 regularly distributed along the loading area 102. For example, the openings 104 are arranged in rows. In the present case, the openings 104 are round or circular in shape and have a round edging.

The roller deck 100 has the roller elements 106, which are arranged in each of the openings 104 and protrude or project from the openings 104. The roller elements 106 form contact points for the objects 200 so that the objects 200 can rest on them and the roller elements 106 can roll on the objects 200. The contact points lie substantially in a common plane for this purpose.

The roller deck 100 also has further openings 105 or recesses which are smaller than the openings 104. One edge of the further openings 105 protrudes from the plane formed by the loading area 102, in particular in the shape of a ring. The further openings 105 are substantially provided as profiling in order to provide a better grip when walking over them. The further openings 105 are provided distributed along the loading area 102 between the openings 104.

In the present case, the loading area 102 is formed from perforated sheet metal segments. The sheet metal segments are square, in particular trapezoidal. The sheet metal segments have, by way of example, between ten and fifty of the openings 104 and optionally a plurality of further openings 105. In the present case, the sheet metal segments are fixed to an underlying base structure of the roller deck 100.

The roller elements 106 are each arranged rotatably about a vertical axis 108 and about a horizontal axis 110, see FIG. 2B. FIG. 2C also shows a single one of the roller elements 106. The roller element 106 has a base part 111, a swivelling part 112 mounted on the base part 111 so as to be rotatable about the vertical axis 108, and a roller 113 mounted so as to be rotatable in the swivelling part 112.

The base part 110 and the swivelling part 112 are made of metal, in particular steel, preferably galvanized steel, in order to be durable. The roller 113 is preferably made of a non-metal material, for example plastic, in order to avoid damaging or scratching objects 200 as far as possible.

Rolling bearings are preferably provided between the base part 110 and the swivelling part 112 and between the swivelling part and the roller 113.

The swivelling part 112 forms a toe guard 114 extending over a surface with two recesses 116. The recesses 116 are provided at the edge of the toe guard 114 in order to adjoin the edging of an opening 104 or to lie opposite thereto in the direction along the loading area 102. The toe guard 114 has a substantially roundly shaped edge or is round. The toe guard 114 corresponds to the opening 114 and is in particular smaller than the opening 114 in order to be able to rotate freely.

The toe guard 114 lies substantially in the plane formed by the loading area 102 or is aligned with it. In contrast, the roller 113 protrudes from the plane or from the toe guard 114. In the present case, the horizontal axis 110 is located away from, in particular below, the plane and in the present case runs at least substantially parallel thereto.

The vertical axis 108 and the horizontal axis 110 run perpendicular to each other and form a distance 118 from each other. Objects 200 lying on top can thus be displaced in any direction along the loading area 102 and the roller element 106 rotates about the vertical axis 108 with little resistance in such a way that the roller 113 can rotate about the horizontal axis 110 with little resistance in accordance with the direction of movement of the respective object 200. In other words, the roller element 106 rotates with an object 200 and as a function of the direction of movement of the object 200.

The base part 111 is to be fastened or is fastened, for example can be screwed or is screwed, in the base structure of the roller deck 100 by means of mounting openings 120. The recesses 116 allow access to the mounting openings 120 along the vertical axis 108 when the roller element 106 is arranged in the opening 104. For example, a tool such as a screwdriver can be inserted into the roller deck 100 through the recesses 116. In addition, an insertion portion of a device can also be inserted into the recesses 116.

FIG. 3 shows a schematic view of one of the devices 1 shown in FIG. 1 and above a roller deck 100.

The device 1 has the insertion portion 20, which comprises two pins 22. The pins 24 form an adjustable distance 24 from each other or between each other. The spacing 24 corresponds to the spacing of the recesses 116 in the roller elements 106, so that the pins 24 can engage in the recesses 116 in one of the openings 104. The pins 24 are arranged in the region of the support portion 26 and are oriented parallel or extend parallel.

The support portion 26 has an inclined or concave shape in order to receive the roller element 106 in regions and not to rest on it or not to rest on it completely or over a large area. This inclined or concave shape is provided on the underside of the securing device 10.

The support portion 26 is provided with a non-slip coating or rubber coating in order to adhere well to the loading area 102.

Adjacent to or above the support portion 26 is a deflection portion 28 in the form of a slope, which forms a ramp extending from the loading area 102. The ramp is circumferential. Objects can run up the ramp and forces can thus be deflected upwards, in particular to strike a stop portion 30.

Above the support portion 26 is the stop portion 30 with an opening or receptacle in which a flexible element 32 is arranged. The flexible element 32 can strike against the objects 200 or the objects 200 can strike against it.

The flexible element 32 has a metal spring encased in rubber.

The stop portion 30, in particular the flexible element 32, is movably connected to the support portion 26 via a joint 29. For example, the joint 29 can be a ball joint.

Adjacent to the stop portion 30 is a receiving portion 40 for receiving the connecting device 50. The receiving portion 40 has a receptacle 42 and is designed to adjustably guide the connecting device 40. Furthermore, a fixing means 44 in the form of a split pin or locking pin is provided, which can provide a releasable form fit 42 between the receptacle and the connecting device 40.

The connecting device 50 has a rod and is elongate. In particular, the connecting device is designed to be telescopic in order to set a distance between the two respective securing devices 10. The distance can alternatively or additionally be adjusted at the receptacle 42 by attaching the fixing means 44 at various points along the connecting device and in the receptacle 42.

The roller deck 100 substantially corresponds to the roller deck 100 shown in FIG. 1 or FIG. 2A-B. In the present case, two of the openings 104 in the loading area 102 are shown in a schematic side view, each with a roller element 106 arranged therein. It can be seen that the roller element 106 with its roller 113 protrudes in portions from the opening 104. A toe guard 114 of the roller element 106 has recesses 116 which are opposite the edging of the opening 104. The pins 22 can be inserted into the openings 104 and thus into the recesses 116 in order to create a form fit along the loading area 102.

The device 1 is shown in a state above the roller deck 100, in which it can be inserted into openings 104 of the roller deck 100, in particular in the direction parallel to vertical axes 108 of roller elements 106 of the roller deck 100. For this purpose, four arrows are drawn, which point from the pins 22 to the roller deck 100.

When the device 1 is inserted into the roller deck 100, the insertion portion 20 can be received at least in portions by the roller elements 106 and/or by the opening 104 and optionally the roller elements 106 can be received at least in portions by the device 1.

FIG. 4 shows a further embodiment of a device 1 for providing a barrier on a roller deck 100. The device 1 is inserted into openings 104 of the roller deck 100.

The roller deck 100 has a loading area 102 made of sheet metal segments with openings 104. Roller elements 106 protrude in portions from the openings 104. A base part of a respective roller element 106, which is concealed in the view of FIG. 4, is fixed to a base structure of the roller deck 100. The loading area 102 is also fixed to the base structure. A swivelling part 112 pivotable about a vertical axis 108 relative to the base part carries a roller rotatable about a horizontal axis. The rollers of the roller elements 106 are covered by the device 1 in this view. The swivelling part 112 also forms a flat toe guard 114 with two recesses 116.

The device 1 is inserted into the two illustrated openings 104 of the loading area 102 of the roller deck 100 by means of at least two securing devices 10. More precisely, two securing devices 10 of the device 1 are each inserted into one of the openings 104. A connecting device 50 in the form of a telescopic rod mechanically connects the two securing devices of the at least two securing devices 10.

The at least two securing devices 10 have insertion portions 20 with two parallel pins 22, which engage or are inserted into the recesses 116 of the toe guard 114 of the respective roller element 106 and thus into the openings 104.

A support portion 26 adjoins each of the insertion portions 20 and rests in the region of the roller deck 100 surrounding the opening 104. Above each of the support portions 26 there is a stop portion 30 with a flexible element 32 against which objects 200 can strike.

Furthermore, the at least two securing devices 10 have a receiving portion 40 with a receptacle 42 for receiving the connecting device 50. A fixing means 44, such as a split pin or a pin, ensures that the connecting device 50 can be detachably fixed in the receptacle 42.

The devices 1 described above can be extended. For example, three or more of the at least two securing devices 10 and two or more connecting devices 50 may be provided, which may be connected in a row or which may be connected in a triangular shape to be inserted into three or more openings 104 of a roller deck 100.

In particular, it is possible that a respective receiving portion 40 can accommodate more than one connecting device 50, for example two connecting devices 50. The accommodated connecting devices 50 can each point in different directions, for example to form the row or the triangle.

A use of a device 1 for providing a barrier for objects 200 resting on a roller deck 100 is shown and described, wherein the device 1 is inserted into two openings 104 of the roller deck 100. The roller deck 100 is provided at an airport or a logistics hub.

### LIST OF REFERENCE SIGNS

1 device
10 securing device
20 insertion portion
22 pin
24 distance
26 support portion
28 deflection portion
29 joint
30 stop portion
32 flexible element
40 receiving portion
42 receptacle
44 fixing means
50 connecting device
100 roller deck
102 loading area
104 opening
105 further opening
106 roller element
108 vertical axis
110 horizontal axis
111 base part
112 swivelling part
113 roller
114 toe guard
116 recess
118 distance
120 mounting opening
200 object

1. A device for providing a barrier for objects resting on a roller deck, wherein the roller deck has a loading area provided with openings, wherein roller elements for supporting the objects protrude from the openings, and wherein the roller elements are each arranged rotatably about a vertical axis and about a horizontal axis, the device comprising:
at least two securing devices, each having an insertion portion for insertion into one of the openings of the roller deck and a support portion for support on a region of the loading area surrounding the opening, and
a connecting device for providing a mechanical connection between two securing devices of the at least two securing devices.

2. The device according to claim 1, wherein the insertion portion comprises in the region of the support portion one pin for engagement in one of the openings.

3. The device according to claim 1, wherein the insertion portion comprises in the region of the support portion two substantially parallel oriented pins for engagement in one of the openings.

4. The device according to claim 3, wherein two of the pins are provided on a securing device of the at least two securing devices, and wherein a distance between the pins is adjustable.

5. The device according to claim 1, wherein the at least two securing devices each comprise a stop portion with a flexible element for stopping the objects.

6. The device according to claim 5, wherein the stop portion adjoins the support portion.

7. The device according to claim 1, wherein the at least two securing devices each comprise a receiving portion for receiving the connecting device.

8. The device according to claim 7, wherein the receiving portion adjoins the stop portion.

9. The device according to claim 7, wherein the receiving portion is designed to adjustably guide the connecting device, and wherein the receiving portion comprises a fixing means for fixing the connecting device in the receiving portion.

10. The device according to claim 9, wherein the fixing means comprises at least one of a split pin and a locking pin.

11. The device according to claim 1, wherein the connecting device at least one of is elongate and comprises a rod.

12. The device according to claim 1, wherein the connecting device is telescopic.

13. The device according to claim 1, wherein three of the at least two securing devices and two or three of the connecting device are provided in a triangular shape.

14. The device according to claim 1, wherein three of the at least two securing devices and two or three of the connecting device are provided at least one to be connected of in a row and to be connected to each other in a triangular shape.

15. The device according to claim 1, wherein three of the at least two securing devices and two or three of the connecting device are provided to be inserted into several of the openings of the roller deck.

16. The device according to claim 15, wherein the three of the at least two securing devices and the two or three of the connecting device are provided to be inserted into three of the openings of the roller deck.

17. A system with a roller deck and with a device, wherein the roller deck has a loading area provided with openings, wherein roller elements for supporting the objects protrude from the openings, wherein the roller elements are each arranged rotatably about a vertical axis and about a horizontal axis, wherein the device is designed according to claim 1.
